(19) United States
(12) Patent Application Publication
(10) Pub. No.: US 2024/0429433 A1
(43) Pub. Date: Dec. 26, 2024

(54) ELECTRODE ASSEMBLY OF RECHARGEABLE BATTERY

(71) Applicant: SAMSUNG SDI CO., LTD., Yongin-si (KR)

(72) Inventors: Daesung RO, Yongin-si (KR); Donghui KIM, Yongin-si (KR); Misun LEE, Yongin-si (KR)

(21) Appl. No.: 18/743,306

(22) Filed: Jun. 14, 2024

(30) Foreign Application Priority Data
Jun. 23, 2023 (KR) 10-2023-0081462

(51) Int. Cl. H01M 10/04; H01M 50/105; H01M 50/595

(52) U.S. Cl. CPC H01M 10/0431; H01M 50/105; H01M 50/595

(57) ABSTRACT

A rechargeable battery electrode assembly includes a first electrode plate and a second electrode plate in a stacked structure, each of the first electrode plate and the second electrode plate including a coated portion and an uncoated region tab, and the uncoated region tab being drawn out, and separators between the first electrode plate and the second electrode plate, each of the separators including a spare portion protruding beyond the coated portion of each of the first electrode plate and the second electrode plate, the spare portion surrounding end portions of the first electrode plate and the second electrode plate, and a protruding length of the spare portion being gradually changed in a direction of stacking the first electrode plate and the second electrode plate in the stacked structure.

### CROSS-REFERENCE TO RELATED APPLICATION

This application claims priority to and the benefit of Korean Patent Application No. 10-2023-0081462, filed in the Korean Intellectual Property Office on Jun. 23, 2023, the entire contents of which are incorporated herein by reference.

### BACKGROUND

### 1. Field

The present disclosure relates to an electrode assembly of a rechargeable battery. More particularly, the present disclosure relates to an electrode assembly of a rechargeable battery, provided with a separator.

### 2. Description of the Related Art

Unlike a primary battery, a rechargeable battery is a battery that performs charging and discharging repeatedly. Small-capacity rechargeable batteries may be used in small and portable electronic devices such as mobile phones, laptop computers, and camcorders. Rechargeable batteries with large capacity and high density may be used as power for driving motors in hybrid vehicles and electric vehicles or for energy storage.

The rechargeable battery may include an electrode assembly for charging and discharging a current, a case or pouch containing the electrode assembly and an electrolyte solution, and an electrode terminal connected to the electrode assembly and drawn out to the outside of the case or pouch. The electrode assembly may be formed as a jelly-roll type formed by winding an electrode plate and a separator, or as a stack type formed by stacking an electrode plate and a separator.

### SUMMARY

An electrode assembly of a rechargeable battery according to an embodiment includes a first electrode plate and a second electrode plate in a stacked structure, each of the first electrode plate and the second electrode plate including a coated portion and an uncoated region tab, and the uncoated region tab being drawn out, and separators between the first electrode plate and the second electrode plate, each of the separators including a spare portion protruding beyond the coated portion of each of the first electrode plate and the second electrode plate, the spare portion surrounding end portions of the first electrode plate and the second electrode plate, and a protruding length of the spare portion being gradually changed in a direction of stacking the first electrode plate and the second electrode plate in the stacked structure.

The uncoated region tab of the first electrode plate and the uncoated region tab of the second electrode plate may be drawn out in a same direction.

The spare portion may include a first protective portion at a first side, the first side being at a same side as the uncoated region tab of the first electrode plate and the uncoated region tab of the second electrode plate, and the first protective portion being configured to protect first end portions of the first electrode plate and the second electrode plate, and a second protective portion at a second side, the second side being opposite the first side and configured to protect second end portions of the first electrode plate and the second electrode plate.

In the first protective portion, the protruding length gradually may increase in the stacking direction, and in the second protective portion, the protruding length gradually may decrease in the stacking direction.

The first protective portion may include a first portion, a second portion, and a third portion that are separated by the uncoated region tab of the first electrode plate and the uncoated region tab of the second electrode plate, the first portion, the second portion, and the third portion being arranged sequentially on the first side, the first portion is wound and taped with a first tape, the second portion is wound and taped with a second tape, and the third portion is wound and taped with a third tape.

The second protective portion may be wound and taped with an additional tape.

The second protective portion may be wound and taped with a first bottom tape and a second bottom tape that are sequentially arranged on the second side.

The first protective portion may include a first portion, a second portion, and a third portion that are separated by the uncoated region tab of the first electrode plate and the uncoated region tab of the second electrode plate, the first portion, the second portion, and the third portion being arranged sequentially on the first side, the second portion is wound and taped with a second tape, and the second protective portion is wound and taped with an additional tape.

The first protective portion may include a first portion, a second portion, and a third portion that are separated by the uncoated region tab of the first electrode plate and the uncoated region tab of the second electrode plate, the first portion, the second portion, and the third portion being arranged sequentially on the first side, the second portion is wound and taped with a second tape, and the second protective portion is wound and taped with a first bottom tape and a second bottom tape that are sequentially arranged on the second side.

The uncoated region tab of the first electrode plate and the uncoated region tab of the second electrode plate may be drawn out in opposite directions in an intersection direction that intersects the stacking direction.

The spare portion may include a first protective portion at a first side, the first side being at a same side as the uncoated region tab of the first electrode plate, and the first protective portion being configured to protect first end portions of the first electrode plate and the second electrode plate, and a second protective portion at a second side, the second side being at a same side as the uncoated region tab of the second electrode plate, and the second protective portion being configured to protect second end portions of the first electrode plate and the second electrode plate.

In the first protective portion, the protruding length may gradually increase in the stacking direction, and in the second protective portion, the protruding length may gradually decrease in the stacking direction.

An electrode assembly of a rechargeable battery according to an embodiment includes a first electrode plate and a second electrode plate in a wound structure, each of the first electrode plate and the second electrode plate including a coated portion and an uncoated region tab, and the uncoated region tab being drawn out, and separators between the first electrode plate and the second electrode plate, each of the separators including a spare portion protruding beyond the coated portion of each of the first electrode plate and the second electrode plate, the spare portion surrounding end portions of the first electrode plate and the second electrode plate, and a protruding length of the spare portion being gradually changed from a center of the wound structure to an outside of the wound structure.

The uncoated region tab of the first electrode plate and the uncoated region tab of the second electrode plate may be drawn out at a same side of the wound structure in a wound axis direction.

The spare portion may include first protective portion at a first side, the first side being at a same side as the uncoated region tab of the first electrode plate and the uncoated region tab of the second electrode plate, and the protruding length in the first protective portion gradually decreasing from the center of the wound structure to the outside of the wound structure, and a second protective portion at a second side, the second side being opposite the first side, and the protruding length in the second protective portion gradually increasing from the center of the wound structure to the outside of the wound structure.

The separators may include a cut portion exposing the uncoated region tab, a depth of the cut portion gradually increasing from one side of the separators to another side of the separators in a length direction of the uncoated region tab.

The uncoated region tab of the first electrode plate and the uncoated region tab of the second electrode plate may be drawn out at different sides of the wound structure in a wound axis direction.

The spare portion may include a first protective portion at a first side, the first side being at a same side as the uncoated region tab of the first electrode plate, and the protruding length in the first protective portion gradually decreasing from the center of the wound structure to the outside of the wound structure, and a second protective portion at a second side, the second side being opposite the first side and at a same side as the uncoated region tab of the second electrode plate, and the protruding length in the second protective portion gradually increasing from the center of the wound structure to the outside of the wound structure.

The separators may include a first cut portion exposing the uncoated region tab of the first electrode plate, a depth of the first cut portion gradually increasing from one side of the separators to another side of the separators in a length direction of the uncoated region tab of the first electrode plate, and a second cut portion exposing the uncoated region tab of the second electrode plate, a depth of the second cut out gradually decreasing from one side of the separators to another side of the separators in a length direction of the uncoated region tab of the second electrode plate.

### BRIEF DESCRIPTION OF THE DRAWINGS

Features will become apparent to those of skill in the art by describing in detail exemplary embodiments with reference to the attached drawings, in which:

FIG. 1 is a top plan view of an electrode assembly of a rechargeable battery according to an embodiment of the present disclosure.

FIG. 2 is a left side view of FIG. 1.

FIG. 3 is a top plan view of a state in which first through third tapes are taped to a first protection portion of FIG. 1.

FIG. 4 is a left side view of a second protection portion of FIG. 1, taped by an additional tape.

FIG. 5 is a top plan view of a state in which the taping of FIG. 3 and FIG. 4 is completed.

FIG. 6 shows an electrode assembly of a rechargeable battery according to an exemplary variation of an embodiment, and is a top plan view of a state in which taping of a second protective portion is completed.

FIG. 7 shows an electrode assembly of a rechargeable battery according to another exemplary variation of an embodiment, and is a top plan view of a state in which taping of a first protective portion is completed.

FIG. 8 shows an electrode assembly of a rechargeable battery according to yet another exemplary variation of an embodiment, and is a top plan view of a state in which taping of a second protective portion is completed.

FIG. 9 is a top plan view of an electrode assembly of a rechargeable battery according to another embodiment of the present disclosure.

FIG. 10 is a left-hand side view of FIG. 9.

FIG. 11 is a top plan view of an electrode assembly of a rechargeable battery according to yet another embodiment of the present disclosure.

FIG. 12 is a top plan view of a separator applied to FIG. 11.

FIG. 13 is a left-hand side of FIG. 11.

FIG. 14 is an enlarged top plan view of a first protective portion formed by meandering of the separator.

FIG. 15 is an enlarged top plan view of a second protective portion formed by the meandering of the separator.

FIG. 16 is a top plan view of an electrode assembly of a rechargeable battery according to still another embodiment of the present disclosure.

FIG. 17 is a top plan view of a separator applied to FIG. 16.

FIG. 18 is a left-hand side view of FIG. 16.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

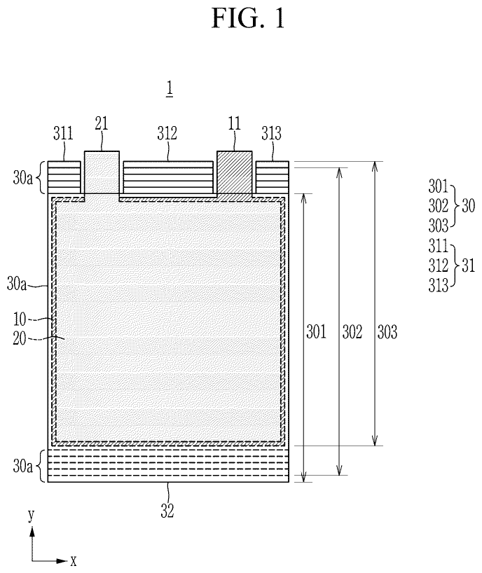

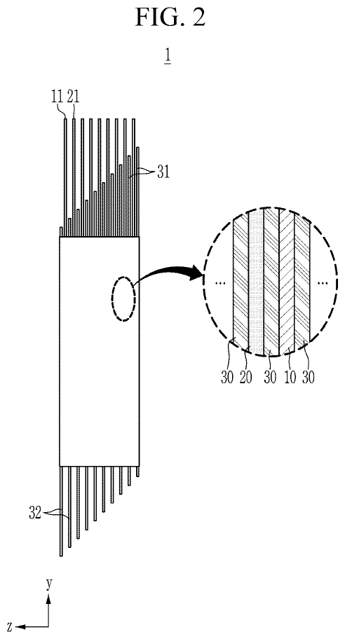

FIG. 1 is a top plan view of an electrode assembly of a rechargeable battery according to an embodiment of the present disclosure, and FIG. 2 is a left side view of FIG. 1. Referring to FIG. 1 and FIG. 2, an electrode assembly 1 of an embodiment may be formed as a stack type including a first electrode plate 10, a second electrode plate 20, and a separator 30. The rechargeable battery is formed by embedding the electrode assembly 1 together with an electrolyte in a pouch or case.

For example, the first electrode plate 10 may be formed as a negative electrode plate and may have a coating portion (e.g., a coated portion) with an active material layer on both sides of an electrode current collector and a first uncoated region tab 11 protruding to one side of the electrode current collector. The first uncoated region tab 11 may be drawn out to the outside of the pouch or case when assembling the rechargeable battery. The electrode current collector may be formed of a thin plate and may be formed of copper.

The second electrode plate 20 may be formed as a positive electrode plate and may have a coating portion with an active material layer on both sides of the electrode current collector and a second uncoated region tab 21 protruding to one side of the electrode current collector. The second uncoated region tab 21 may be drawn out to the outside of the pouch or case when assembling the rechargeable battery. The electrode current collector may be formed of a thin plate and may be formed of aluminum.

A material that forms the electrode current collector of the first electrode plate 10 and the second electrode plate 20 may be any material that does not react with lithium, i.e., any non-conductive material that does not form an alloy or compound with lithium. For example, the material may be a metal or an alloy. The first and second electrode plates 10 and 20 are described as positive and negative electrode plates, but may be interchanged depending on the situation.

The metal of the electrode current collector may be, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. The electrode current collector may have any form selected from, e.g., sheets, foils, films, plates, porous materials, mesoporous materials, perforated materials, polygon rings, mesh materials, foams, and non-woven fabric materials.

For example, referring to FIGS. 1 and 2, the separators 30 may be cut corresponding to the first and second uncoated region tabs 11 and 21. In another example, the separators 30 may be used by cutting portions corresponding to the first uncoated region tab 11 and the second uncoated region tab 21 in a state of being disposed between the first electrode plate 10 and the second electrode plate 20 and stacked. In this case, a portion of the separators 30 disposed between the first uncoated region tabs 11 of the first electrode plate 10 and a portion of the separators 30 disposed between the second uncoated region tabs 21 of the second electrode plate 20 need to be removed.

The first uncoated region tab 11 and the second uncoated region tab 21 may be drawn out on the same side or on opposite sides of the electrode assembly 1. For example, referring to FIG. 1, the first uncoated region tab 11 and the second uncoated region tab 21 may be drawn out to the same side. That is, the first uncoated region tab 11 and the second uncoated region tab 21 may be drawn out on the same side (e.g., upward direction in FIG. 1 and FIG. 2) in the intersection direction (y-axis direction) that intersects the stacking direction (z-axis direction).

The plurality of first uncoated region tabs 11 may be gathered into one (e.g., the plurality of first uncoated region tabs 11 may be stacked to overlap each other in the z-axis direction to define one group) and drawn out outside the pouch or case. In addition, the plurality of second uncoated region tabs 21 may be gathered into one (e.g., the plurality of second uncoated region tabs 21 may be stacked to overlap each other in the z-axis direction to define one group) and drawn out outside the pouch or case. The second uncoated region tabs 21 are electrically separated from the first uncoated region tabs 11 in the x-axis direction.

Referring to FIG. 1, the separators 30 may form a spare portion 30a that protrudes farther than a coating portion from a drawn-out side (i.e., a side of the electrode assembly 1 from which the first and second uncoated regions tabs 11 and 21 are drawn out) and from the opposite side of the first and second uncoated regions tabs 11 and 21, and may surround end portions of the first electrode plate 10 and the second electrode plate 20. For example, referring to FIG. 1, the spare portion 30a of the separators 30 may be a portion of the separators 30 extending farther than (e.g., beyond) the first electrode plate 10 and the second electrode plate 20 in each of the x-axis direction (beyond the dashed line in FIG. 1) and the y-axis direction around an entire perimeter of the stacked first and second electrode plates 10 and 20, with the exception of the first and second uncoated regions tabs 11 and 21, as viewed in the xy plane.

In FIG. 1, among the separators 30, a first separator 301 disposed topmost (e.g., leftmost in the z-axis direction of FIG. 2) may be disposed most biased downward in the y-axis direction (e.g., may be positioned lowermost in the y-axis direction), and a last separator 303 disposed bottommost (e.g., rightmost in the z-axis direction of FIG. 2) may be disposed most biased upward in the y-axis direction (e.g., may be positioned uppermost in the y-axis direction). In addition, middle separators 302, which are disposed between the first separator 301 and the last separator 303, may be more gradually biased upward in the y-axis direction as they move upward (e.g., may be spaced apart from each other in the z-axis direction (FIG. 2) and may be positioned at gradually increasing heights in the y-axis direction (FIGS. 1 and 2) in a direction oriented from the first separator 301 toward the last separator 303).

Therefore, the separators 30 may have margins of different lengths in the y-axis direction (e.g., the separators 30 may have increasing lengths of margins in the y-axis direction in a region beyond the stacked first and second electrode plates 10 and 20). In other words, the protruding length in the y-axis direction of the spare portion of each of the separators 30 changes gradually in the stacking direction (z-axis direction) of the first electrode plate 10 and the second electrode plate 20. The spare portion of each of the separators 30 may include a first protective portion 31 and a second protective portion 32, which will be described later. For example, referring to FIG. 2, two adjacent separators 30 in the z-axis direction (i.e., two adjacent first protective portions 31 of two adjacent separators 30) may extend to different lengths in the y-axis direction in a region outside the stacked first and second electrode plates 10 and 20.

Since the protruding lengths of the spare portions gradually change along the stacking direction in the separators 30 to further surround the end portions of the first electrode plate 10 and the second electrode plate 20, electrical short-circuit between the first electrode plate 10 and the second electrode plate 20 can be prevented or substantially minimized. If the rechargeable battery is dropped, the first electrode plate 10 and the second electrode plate 20 may flow on both sides of the separator 30, and the spare portion of the separator 30 (i.e., the first and second protective portions 31 and 32 of the separator 30) may absorb the impact of the drop and minimize the damage to the first electrode plate 10 and the second electrode plate 20, thereby further preventing the electrical short circuit.

Referring to FIGS. 1 and 2, in the spare portion of the separator 30 in an embodiment, the first protective portion 31 surrounds the end portions of the first electrode plate 10 and the second electrode plate 20 on the first and second uncoated region tabs 11 and 21 side (i.e., upward side of the y-axis direction in FIGS. 1 and 2) such that damage and movement from impact can be minimized. To this end, in the first protective portion 31, the protruding length gradually increases in the stacking direction (to the right of the z-axis direction in FIG. 2).

The second protective portion 32 surrounds the end portions of the first electrode plate 10 and the second electrode plate 20 on the opposite side (i.e., downward of y-axis direction in FIGS. 1 and 2) of the first and second uncoated regions tabs 11 and 21 to minimize damage and movement due to the impact. To this end, in the second protective portion 32, the protruding length gradually decreases in the stacking direction (i.e., the right of z-axis direction in FIG. 2).

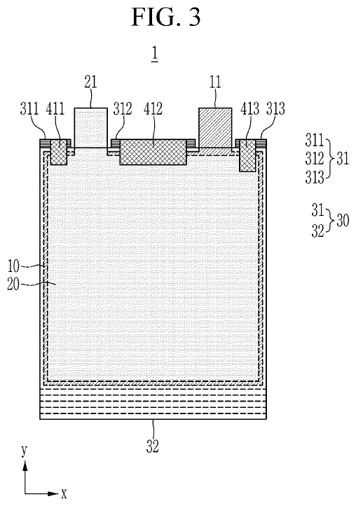

FIG. 3 is a top plan view of a state in which the first protective portion of FIG. 1 is taped with first through third tapes. Referring to FIG. 1 to FIG. 3, the first protective portion 31 may include a first portion 311, a second portion 312, and a third portion 313 that are separated from each other in the x-axis direction by the first and second uncoated region tabs 11 and 21 and sequentially disposed along the x-axis direction at one side. Referring to FIG. 3, the first portion 311 may be wound and taped with a first tape 411 to strengthen a buffering and insulating structure in the first portion 311. The second portion 312 may be wound and taped with a second tape 412 to strengthen a buffering and insulating structure in the second portion 312. The third portion 313 may be wound and taped with a third tape 413 to strengthen a buffering and insulating structure in the third portion 313.

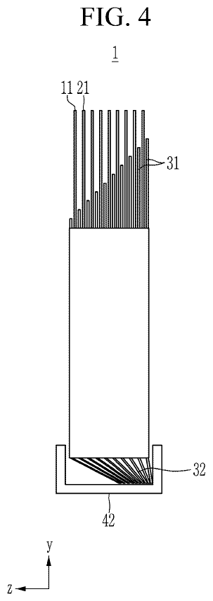

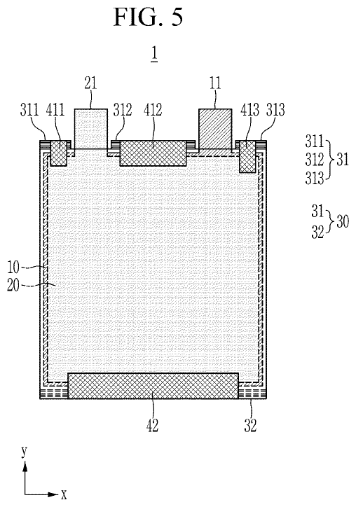

FIG. 4 is a left-hand side view of taping the second protective portion with an additional tape, and FIG. 5 is a top plan view of a state in which the taping of FIG. 3 and FIG. 4 is completed. Referring to FIG. 1 to FIG. 5, the second protective portion 32 may be taped with an additional tape 42 (e.g., a protective gear tape) to strengthen a buffering and insulating structure in the second protective portion 32.

Hereinafter, various exemplary variations and embodiments of the present disclosure will be described. Compared to the embodiment in FIGS. 1-5, descriptions of the same configuration are omitted and descriptions of different configurations are provided.

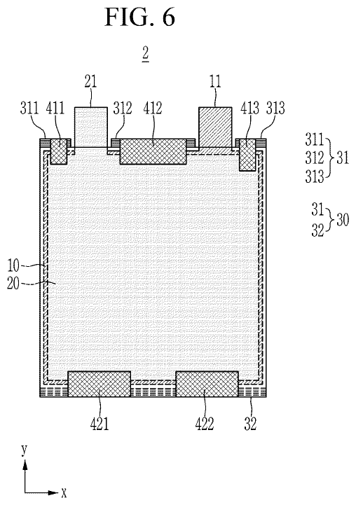

FIG. 6 shows an electrode assembly of a rechargeable battery according to an exemplary variation of the embodiment in FIGS. 1-5, and is a top plan view of a state in which taping of a second protective portion is completed.

Referring to FIG. 6, in an electrode assembly 2, the second protective portion 32 on a side of the electrode assembly 2 that is opposite the first and second uncoated region tabs 11 and 21 may be taped with a first bottom tape 421 and a second bottom tape 422. The first and second bottom tapes 421 and 422 may be wound and sequentially disposed on a same side of the electrode assembly 2 to strengthen a buffering and insulating structure in the second protective portion 32. Since the first and second bottom tapes 421 and 422 are formed separately (e.g., the first and second bottom tapes 421 and 422 may be spaced apart from each other along the x-axis direction), it may be easier to wind and tape the second protective portion 32 (e.g., compared to the additional tape 42 of the embodiment in FIGS. 1-5 that is formed as a single long tape overlapping continuously both the first and second uncoated region tabs 11 and 21).

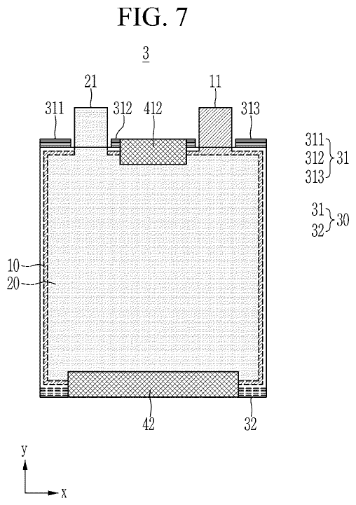

FIG. 7 shows an electrode assembly of a rechargeable battery according to another exemplary variation of the embodiment in FIGS. 1-5, and is a top plan view of a state in which taping of a first protective portion is completed.

Referring to FIG. 7, in an electrode assembly 3, the first protective portion 31 on a side of the electrode assembly 3 that includes the first and second uncoated region tabs 11 and 21 may be separated in the x-axis direction by the first and second uncoated region tabs 11 and 21 into the first portion 311, the second portion 312, and the third portion 313 are sequentially disposed along the x-axis direction on a same side. The first protective portion 31 in the electrode assembly 3 may be taped only with the second tape 412.

Referring to FIG. 7, the first portion 311 may be wound and form a strengthened buffering and insulation structure without being taped. The second portion 312 may be wound and taped with the second tape 412 to form a strengthened buffering and insulating structure in the second portion 312. The third portion 313 may be wound and form a strengthened buffering and insulation structure without being taped. Since the first protective portion 31 is provided with one second tape 412, taping work may be simplified (e.g., compared to the multiple tapes in the embodiment in FIGS. 1-5).

The second protective portion 32 may be wound and taped with the additional tape 42 to form a strengthened buffering and insulating structure in the second protective portion 32. The second protective portion 32 may have the same effect as that of the embodiment in FIGS. 1-5.

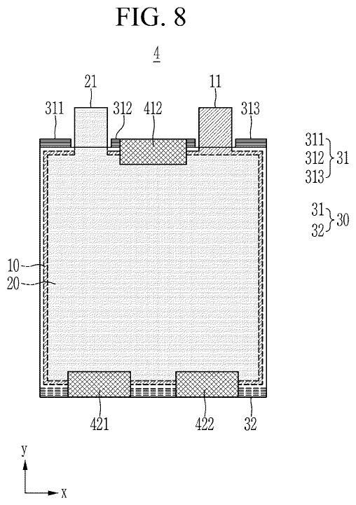

FIG. 8 shows an electrode assembly of a rechargeable battery according to yet another exemplary variation of the embodiment in FIGS. 1-5, and is a top plan view of a state in which taping of a second protective portion is completed.

Referring to FIG. 8, in an electrode assembly 4, the first portion 311 may be wound and strengthens a buffering and insulation structure without being taped. The second portion 312 may be wound and taped with the second tape 412 to form a strengthened buffering and insulating structure in the second portion 312. The third portion 313 may be wound and strengthens a buffering and insulation structure without being taped. Since the first protective portion 31 is provided with one second tape 412, taping work may be simplified (e.g., compared to the embodiment in FIGS. 1-5 that is further provided with the first and third tapes 411 and 413).

The second protective portion 32 may be taped with the first bottom tape 421 and the second bottom tape 422 that are wound and sequentially disposed on a same side and strengthen a buffering and insulation structure in the second protective portion 32. Since the first and second bottom tapes 421 and 422 are formed separately, it may be easier to wind and tape the second protective portion 32 (e.g., compared to the additional tape 42 of the embodiment in FIGS. 1-5 that is formed as one).

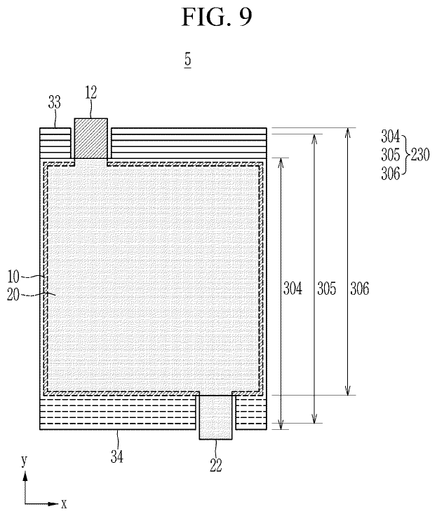

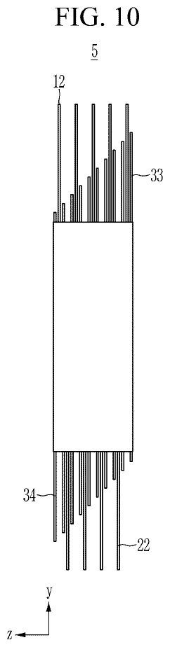

FIG. 9 is a top plan view of an electrode assembly of a rechargeable battery according to another embodiment of the present disclosure. FIG. 10 is a left-hand side view of FIG. 9.

Referring to FIG. 9 and FIG. 10, an electrode assembly 5 may include a first uncoated region tab 12 of the first electrode plate 10 and a second uncoated region tab 22 of the second electrode plate 20 that are drawn out on opposite sides. That is, the first uncoated region tab 12 and the second uncoated region tab 22 may be drawn out on opposite sides (upward and downward directions in FIG. 9 and FIG. 10) in the intersection direction (y-axis direction) that intersects the stacking direction (z-axis direction).

A plurality of first uncoated region tabs 12 may be gathered together at a top and drawn out to the outside of a pouch or case. In addition, a plurality of second uncoated region tabs 22 may be gathered together at a bottom and drawn out to the outside of the pouch or case.

Referring to FIGS. 9 and 10, separators 230 may protrude from a coating portion on the drawn-out side of the first uncoated region tab 12 and the drawn-out side of the second uncoated region tab 22 to form a spare portion that further surrounds end portions of the first electrode plate 10 and the second electrode plate 20. The separators 230 may include a first separator 304, a last separator 306, and middle separators 305 between the first separator 304 and the last separator 306.

Referring to FIG. 9, the first separator 304 disposed at the topmost (e.g., leftmost in the z-axis direction in FIG. 10) among the separators 230 may be disposed most biased downward in the y-axis direction (FIG. 9), and the last separator 306 disposed at the bottommost (e.g., rightmost in the z-axis direction in FIG. 10) may be disposed most biased upward in the y-axis direction (FIG. 9). In addition, the middle separators 305, which are disposed between the first separator 304 and the last separator 306, may be more gradually biased upward in the y-axis direction as they move upward.

Therefore, the separators 230 may have margins of different lengths in the y-axis direction. In other words, the protruding length of the spare portion of the separators 230 changes gradually in the stacking direction (z-axis direction) of the first electrode plate 10 and the second electrode plate 20. The spare portion includes a first protective portion 33 and a second protective portion 34, which will be described later.

Since the protruding length of the spare portion gradually changes along the stacking direction in the separator 230 to further surround the end portions of the first electrode plate 10 and the second electrode plate 20, electrical short-circuit between the first electrode plate 10 and the second electrode plate 20 may be prevented or substantially minimized. If the rechargeable battery is dropped, the first electrode plate 10 and the second electrode plate 20 may flow on both sides of the separator 230, and the spare portion of the separator 230 (i.e., the first and second protective portions 33 and 34) may absorb the impact of the drop and minimize the damage to the first electrode plate 10 and the second electrode plate 20, thereby further preventing the electrical short circuit.

Referring to FIGS. 9 and 10, in the spare portion of the separator 230, the first protective portion 33 may surround the end portions of the first electrode plate 10 and the second electrode plate 20 on the first uncoated region tab 12 side (i.e., upward side of the y-axis direction) such that damage and movement from impact can be minimized. To this end, in the first protective portion 33, the protruding length gradually increases in the stacking direction (along the right in the z-axis direction in FIG. 10). In addition, the first protective portion 33 may be cut at the first uncoated region tab 12 and separated on both sides in the x-axis direction, allowing separate taping on both sides. The separated portions of the first protective portion 33 are each taped to strengthen a buffering and insulating structure in the first protective portion 33.

The second protective portion 34 may surround the end portions of the first electrode plate 10 and the second electrode plate 20 on the second uncoated region tab 22 side (downwards in the y-axis direction) to minimize damage and movement from impact. To this end, in second protective portion 34, the protruding length gradually decreases in the stacking direction (along the right in the z-axis direction in FIG. 10). In addition, the second protective portion 34 may be cut at the second uncoated region tab 22 and separated on both sides in the x-axis direction, allowing separate taping on both sides. The separated portions of the second protective portion 34 may be each taped to form a strengthened buffering and insulating structure in the second protective portion 34.

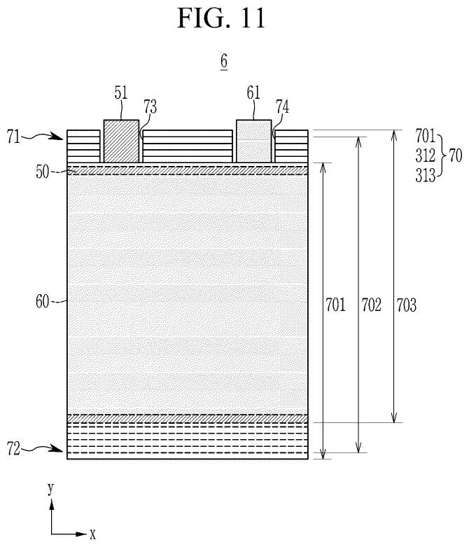

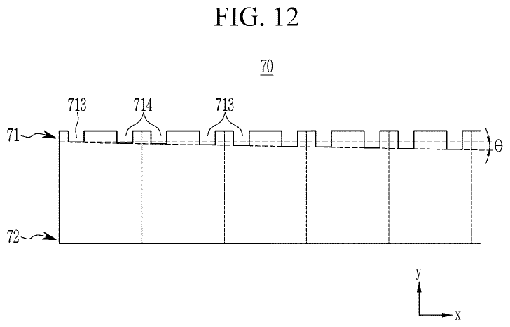

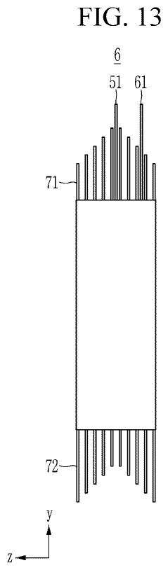

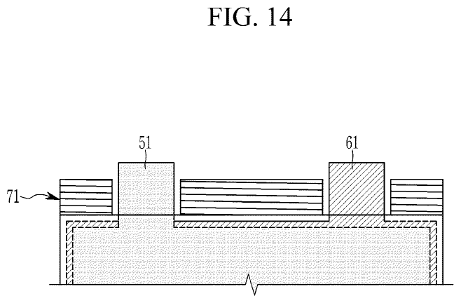

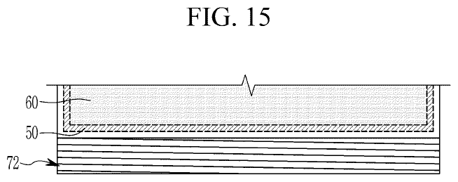

FIG. 11 is a top plan view of an electrode assembly of a rechargeable battery according to yet another embodiment of the present disclosure. FIG. 12 is a top plan view of a separator applied to FIG. 11. FIG. 13 is a left-hand side of FIG. 11. FIG. 14 is an enlarged top plan view of a first protective portion formed by meandering of the separator. FIG. 15 is an enlarged top plan view of a second protective portion formed by the meandering of the separator.

Referring to FIG. 11 to FIG. 15, an electrode assembly 6 may be formed as a jelly roll type including a first electrode plate 50, a second electrode plate 60, and separators 70.

The first electrode plate 50 may be formed as a negative electrode plate, and may be provided with a coating portion with an active material layer on both sides of a bar-shaped electrode current collector and one or more of first uncoated region tabs 51 protruding on one side of the electrode current collector. The second electrode plate 60 may be formed as a positive electrode plate and may be provided with a coating portion with an active material layer on both sides of the bar-shaped electrode current collector and one or more second uncoated region tabs 61 protruding to one side of the electrode current collector.

The first uncoated region tab 51 and the second uncoated region tab 61 may be drawn out on the same side or on opposite sides of the electrode assembly 6. In the electrode assembly 6, the first uncoated region tab 51 and the second uncoated region tab 61 may be drawn out to the same side. That is, the first uncoated region tab 51 and the second uncoated region tab 61 may be drawn out on the same side (upward in FIG. 11 to FIG. 13) in the intersection direction (y-axis direction) that intersects the stacking direction (z-axis direction).

A plurality of first uncoated region tabs 51 may be gathered into one and drawn out to the outside of a pouch or case. In addition, a plurality of second uncoated region tabs 61 may be gathered into one and drawn out outside the pouch or case. The second uncoated region tabs 61 may be spaced apart and electrically separated from the first uncoated region tabs 51 in the x-axis direction.

Referring to FIG. 11, the separators 70 may protrude from the coating portion on the drawn-out side (i.e., the side including the first and second uncoated region tabs 51 and 61) and the opposite side of the first and second uncoated regions tabs 51 and 61 to form spare portions that further surround end portions of the first electrode plate 50 and the second electrode plate 60. The separators 70 may include an outermost separator 701, a central separator 703, and middle separators 702.

In FIG. 11, the outermost separator 701 disposed at the outermost among the separators 70 (FIG. 13) may be disposed most biased downward in the y-axis direction, and the central separator 703 disposed at a center (FIG. 13) may be disposed most biased upward in the y-axis direction. In addition, the middle separators 702, which are disposed between the outermost separator 701 and the central separator 703, may be disposed more gradually biased as they move upward in the y-axis direction. Therefore, the separators 70 may have spare portions of different lengths in the y-axis direction. In other words, the protruding length of the spare portions change gradually from a wound center of the first electrode plate 50 and the second electrode plate 60 to the outside (z-axis direction). The spare portion may include a first protective portion 71 and a second protective portion 72, which will be described later.

The protruding length of the spare portion in the separator 70 changes gradually from the wound center to the outside to further surround the end portions of the first electrode plate 50 and the second electrode plate 60, thereby preventing or substantially minimizing electrical short-circuiting between the first electrode plate 50 and the second electrode plate 60. If the rechargeable battery is dropped, the first electrode plate 50 and the second electrode plate 60 may move on both sides of the separator 70, and the spare portion of the separator 70 (i.e., the first and second protective portions 71 and 72) may absorb the impact of the drop and minimize the damage to the first electrode plate 50 and the second electrode plate 60, thereby further preventing the electrical short-circuit of the first electrode plate 50 and the second electrode plate 60.

Referring to FIG. 11, in the spare portion of the separators 70, the first protective portion 71 surrounds the end portions of the first electrode plate 50 and the second electrode plate 60 on the first and second uncoated region tabs 51 and 61 side (upward side in the y-axis direction), thereby minimizing damage and movement from impact. To this end, in the first protective portion 71, the protruding length gradually decreases from the wound center to the outside (FIG. 13). The second protective portion 72 surrounds the end portions of the first electrode plate 50 and the second electrode plate 60 on the opposite side (downward y-axis direction) of the first and second uncoated regions tabs 51 and 61 to minimize damage and movement due to the impact. To this end, in the second protective portion 72, the protruding length gradually increases from the wound center to the outside (FIG. 13).

Referring to FIG. 12, the separators 70 may expose the first and second uncoated region tabs 51 and 61 with cut portions 713 and 714 cut to correspond to (e.g., overlap) the first and second uncoated region tabs 51 and 61. A depth of the cut portions 713 and 714 gradually increases from one side of the length direction of the separators 70 to the other side. Therefore, the depth increase of the cut portions 713 and 714 provided on the first protective portion 71 side has a slope of a predetermined angle θ.

The separators 70 may be disposed between the first electrode plate 50 and the second electrode plate 60 and on one exterior surface (e.g., on an exterior surface of at least one of the first and second electrode plates 50 and 60), and may be wound in a meandering manner (e.g., the separators 70 with the first and second electrode plates 50 and 60 may be wound into a jelly roll or wound structure). Therefore, in the first protective portion 71, the protruding length gradually decreases from the wound center to the outside, and in the second protective portion 72, the protruding length gradually increases from the wound center to the outside. The first and second protective portions 71 and 72 may be wound and taped to form a strengthened buffering and insulating structure in the first and second protective portions 71 and 72.

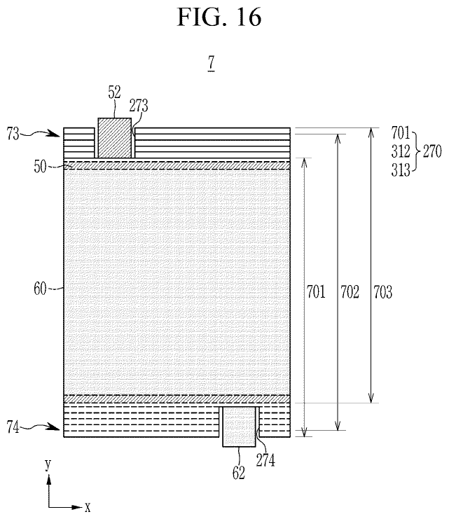

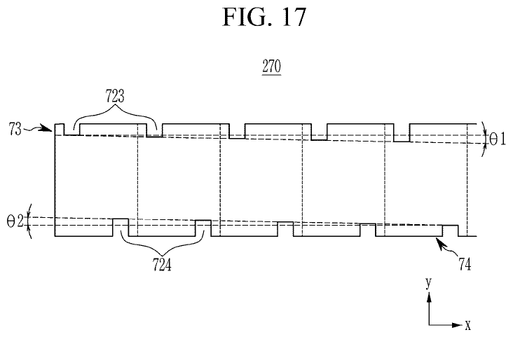

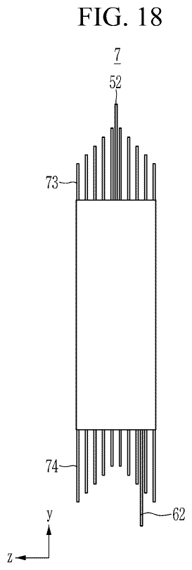

FIG. 16 is a top plan view of an electrode assembly of a rechargeable battery according to still another embodiment of the present disclosure. FIG. 17 is a top plan view of a separator applied to FIG. 16. FIG. 18 is a left-hand side view of FIG. 16.

Referring to FIG. 16 to FIG. 18, in an electrode assembly 7, a first uncoated region tab 52 of the first electrode plate 50 and a second uncoated region tab 62 of the second electrode plate 60 may be drawn out on opposite sides. That is, the first uncoated region tab 52 and the second uncoated region tab 62 may be drawn out on different sides in the wound axis direction (y-axis direction).

The plurality of first uncoated region tabs 52 may be gathered together at an upper portion of the y-axis direction and drawn out to the outside of the pouch or case. In addition, the plurality of second uncoated region tabs 62 may be gathered together at a lower portion of the y-axis direction and drawn out to the outside of the pouch or case.

Referring to FIG. 16, separators 270 may protrude from a coating portion to the draw-out side of the first uncoated region tab 52 and the draw-out side of the second uncoated region tab 62 to form a spare portion that further surrounds end portions of the first electrode plate 50 and the second electrode plate 60.

In the spare portion, a first protective portion 73 surrounds the end portions of the first electrode plate 50 and the second electrode plate 60 on the first uncoated region tab 52 side (upward in the y-axis direction) to minimize damage and movement due to impact. To this end, in the first protective portion 73, the protruding length gradually decreases from a center to the outside of the wound direction. In addition, the first protective portion 73 may be cut at the first uncoated region tab 52 and separated on both sides in the x-axis direction, allowing separate taping on both sides. The separated portions of the first protective portion 73 may be each taped to form a strengthened buffering and insulating structure in the first protective portion 73.

The second protective portion 74 may surround the end portions of the first electrode plate 50 and the second electrode plate 60 on the second uncoated region tab 62 side (downwards in the y-axis direction) to minimize damage and movement due to impact. To this end, in the second protective portion 74, the protruding length gradually increases from the center to the outside of the wound direction. In addition, the second protective portion 74 may be cut at the second uncoated region tab 62 and separated on both sides in the x-axis direction, allowing separate taping on both sides. The separated portions of the second protective portion 74 may be each taped to form a strengthened buffering and insulating structure in the second protective portion 74.

Referring to FIG. 17, the separators 270 may expose the first and second uncoated region tabs 52 and 62 with a first cut portion 723 and a second cut portion 724 cut in response to (e.g., to overlap) the first and second uncoated region tabs 52 and 62. A depth of the first cut portion 723 gradually increases as it goes from one side (left side of the drawing) to the other side (right side of the drawing) in a length direction of the separators 270 (e.g., in the x-axis direction in FIG. 17). Therefore, the depth increase of the first cut portion 723 provided on the first protective portion 73 side may have a slope of a predetermined first angle θ1. In addition, a depth of the second cut portion 724 gradually increases from one side of the length direction of the separators 270 (right side of the drawing) to the other side (left side of the drawing). Therefore, the depth increase of the second cut portion 724 provided on the second protective portion 74 side may have a slope of a predetermined second angle θ2.

The separators 270 may be disposed between the first electrode plate 50 and the second electrode plate 60 and on one exterior surface, and may be wound in a meandering manner. Therefore, in the first protective portion 73, the protruding length gradually decreases from the wound center to the outside, and in the second protective portion 74, the protruding length gradually increases from the wound center to the outside. The first and second protective portions 73 and 74 may be wound and taped to form a strengthened buffering and insulating structure in the first and second protective portions 73 and 74.

By way of summation and review, an electrode assembly may include separators that form an area larger than the electrode plate. The separators may protrude to the outside of the positive electrode plate and negative electrode plate regardless of the winding or stacking position of the positive electrode plate and negative electrode plate, and may electrically insulate the positive electrode plate and negative electrode plate from each other. In this case, the separators may be produced with the same length.

However, when the rechargeable battery is dropped, the electrode assembly may move, thereby causing damage to the positive and negative electrode plates. In this case, the separator disposed between the positive electrode plate and the negative electrode plate may be deformed and the insulating performance of the separator may be deteriorated, thereby causing an electrical short circuit between the positive electrode plate and the negative electrode plate.

In contrast, an embodiment of the present disclosure provides an electrode assembly of a rechargeable battery, which strengthens a structure of a separator to prevent electrical short-circuiting of electrode plates. An embodiment of the present disclosure provides an electrode assembly of a rechargeable battery, which can prevent electrical short-circuiting of electrode plates even when the electrode plates move on both sides of the separator due to a drop of the rechargeable battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery electrode assembly, comprising:
a first electrode plate and a second electrode plate in a stacked structure, each of the first electrode plate and the second electrode plate including a coated portion and an uncoated region tab, and the uncoated region tab being drawn out; and
separators between the first electrode plate and the second electrode plate, each of the separators including a spare portion protruding beyond the coated portion of each of the first electrode plate and the second electrode plate, the spare portion surrounding end portions of the first electrode plate and the second electrode plate, and a protruding length of the spare portion being gradually changed in a direction of stacking the first electrode plate and the second electrode plate in the stacked structure.

2. The rechargeable battery electrode assembly as claimed in claim 1, wherein the uncoated region tab of the first electrode plate and the uncoated region tab of the second electrode plate are drawn out in a same direction.

3. The rechargeable battery electrode assembly as claimed in claim 2, wherein the spare portion includes:
a first protective portion at a first side, the first side being at a same side as the uncoated region tab of the first electrode plate and the uncoated region tab of the second electrode plate, and the first protective portion being configured to protect first end portions of the first electrode plate and the second electrode plate; and
a second protective portion at a second side, the second side being opposite the first side and configured to protect second end portions of the first electrode plate and the second electrode plate.

4. The rechargeable battery electrode assembly as claimed in claim 3, wherein:
in the first protective portion, the protruding length gradually increases in a stacking direction, and
in the second protective portion, the protruding length gradually decreases in the stacking direction.

5. The rechargeable battery electrode assembly as claimed in claim 4, wherein:
the first protective portion includes a first portion, a second portion, and a third portion that are separated by the uncoated region tab of the first electrode plate and the uncoated region tab of the second electrode plate, the first portion, the second portion, and the third portion being arranged sequentially on the first side,
the first portion is wound and taped with a first tape,
the second portion is wound and taped with a second tape, and
the third portion is wound and taped with a third tape.

6. The rechargeable battery electrode assembly as claimed in claim 5, wherein the second protective portion is wound and taped with an additional tape.

7. The rechargeable battery electrode assembly as claimed in claim 5, wherein the second protective portion is wound and taped with a first bottom tape and a second bottom tape that are sequentially arranged on the second side.

8. The rechargeable battery electrode assembly as claimed in claim 4, wherein:
the first protective portion includes a first portion, a second portion, and a third portion that are separated by the uncoated region tab of the first electrode plate and the uncoated region tab of the second electrode plate, the first portion, the second portion, and the third portion being arranged sequentially on the first side,
the second portion is wound and taped with a second tape, and
the second protective portion is wound and taped with an additional tape.

9. The rechargeable battery electrode assembly as claimed in claim 4, wherein:
the first protective portion includes a first portion, a second portion, and a third portion that are separated by the uncoated region tab of the first electrode plate and the uncoated region tab of the second electrode plate, the first portion, the second portion, and the third portion being arranged sequentially on the first side,
the second portion is wound and taped with a second tape, and
the second protective portion is wound and taped with a first bottom tape and a second bottom tape that are sequentially arranged on the second side.

10. The rechargeable battery electrode assembly as claimed in claim 1, wherein the uncoated region tab of the first electrode plate and the uncoated region tab of the second electrode plate are drawn out in opposite directions in an intersection direction that intersects a stacking direction.

11. The rechargeable battery electrode assembly as claimed in claim 10, wherein the spare portion includes:
a first protective portion at a first side, the first side being at a same side as the uncoated region tab of the first electrode plate, and the first protective portion being configured to protect first end portions of the first electrode plate and the second electrode plate; and
a second protective portion at a second side, the second side being at a same side as the uncoated region tab of the second electrode plate, and the second protective portion being configured to protect second end portions of the first electrode plate and the second electrode plate.

12. The rechargeable battery electrode assembly as claimed in claim 11, wherein:
in the first protective portion, the protruding length gradually increases in the stacking direction, and
in the second protective portion, the protruding length gradually decreases in the stacking direction.

13. A rechargeable battery electrode assembly, comprising:
a first electrode plate and a second electrode plate in a wound structure, each of the first electrode plate and the second electrode plate including a coated portion and an uncoated region tab, and the uncoated region tab being drawn out; and
separators between the first electrode plate and the second electrode plate, each of the separators including a spare portion protruding beyond the coated portion of each of the first electrode plate and the second electrode plate, the spare portion surrounding end portions of the first electrode plate and the second electrode plate, and a protruding length of the spare portion being gradually changed from a center of the wound structure to an outside of the wound structure.

14. The rechargeable battery electrode assembly as claimed in claim 13, wherein the uncoated region tab of the first electrode plate and the uncoated region tab of the second electrode plate are drawn out at a same side of the wound structure in a wound axis direction.

15. The rechargeable battery electrode assembly as claimed in claim 14, wherein the spare portion includes:
a first protective portion at a first side, the first side being at a same side as the uncoated region tab of the first electrode plate and the uncoated region tab of the second electrode plate, and the protruding length in the first protective portion gradually decreasing from the center of the wound structure to the outside of the wound structure; and
a second protective portion at a second side, the second side being opposite the first side, and the protruding length in the second protective portion gradually increasing from the center of the wound structure to the outside of the wound structure.

16. The rechargeable battery electrode assembly as claimed in claim 13, wherein the separators include a cut portion exposing the uncoated region tab, a depth of the cut portion gradually increasing from one side of the separators to another side of the separators in a length direction of the uncoated region tab.

17. The rechargeable battery electrode assembly as claimed in claim 13, wherein the uncoated region tab of the first electrode plate and the uncoated region tab of the second electrode plate are drawn out at different sides of the wound structure in a wound axis direction.

18. The rechargeable battery electrode assembly as claimed in claim 17, wherein the spare portion includes:
a first protective portion at a first side, the first side being at a same side as the uncoated region tab of the first electrode plate, and the protruding length in the first protective portion gradually decreasing from the center of the wound structure to the outside of the wound structure; and
a second protective portion at a second side, the second side being opposite the first side and at a same side as the uncoated region tab of the second electrode plate, and the protruding length in the second protective portion gradually increasing from the center of the wound structure to the outside of the wound structure.

19. The rechargeable battery electrode assembly as claimed in claim 13, wherein the separators include:
a first cut portion exposing the uncoated region tab of the first electrode plate, a depth of the first cut portion gradually increasing from one side of the separators to another side of the separators in a length direction of the uncoated region tab of the first electrode plate; and
a second cut portion exposing the uncoated region tab of the second electrode plate, a depth of the second cut portion gradually decreasing from one side of the separators to another side of the separators in a length direction of the uncoated region tab of the second electrode plate.
